(19) United States
(12) Patent Application Publication
(10) Pub. No.: US 2008/0196239 A1
(43) Pub. Date: Aug. 21, 2008

(54) Method for forming windings of a transformer

(75) Inventor: Feng Jin Wang, Shenzhen (CN)

Correspondence Address: GLOBAL IP SERVICES, 7285 W. Eagle Court, Winton, CA, 95388, US

(73) Assignee: Shenzhen Putly Optic-Electronic Technology Co., Ltd., Shenzhen (CN)

(21) Appl. No.: 12/031,690

(22) Filed: Feb. 14, 2008

(30) Foreign Application Priority Data
Feb. 16, 2007 (CN) 200710073374.6
Feb. 16, 2007 (CN) 200710073375.0
Feb. 16, 2007 (CN) 200710073376.5
Feb. 16, 2007 (CN) 200710073377.X

(51) Int. Cl. H01F 7/06

(52) U.S. Cl. 29/605; 29/602.1; 336/221

(57) ABSTRACT

A method for forming windings of a transformer comprises enwinding windings on a plurality of magnetic circuits of a transformer, so as to reduce the requirements of manufacturing materials of the windings, machine process and manufacturing environment and save the manufacturing cost.

### CROSS-REFERENCE TO RELATED APPLICATION

This application claims the priority rights of Chinese patent applications No. 200710073377.X, 200710073374.6, 200710073375.0, 200710073376.5, all were filed on Feb. 16, 2007.

### BACKGROUND OF THE INVENTION

1. Field of the Invention

The present invention relates to a transformer, especially relates to a method for forming windings of a transformer.

2. Description of the Related Art

A transformer is a device for transforming voltage, current and resistance of alternating current. The transformer includes magnetic cores and coils wherein the coils have two or more windings. The windings and the magnetic cores are named electric transformer body and serve as a circuit part for establishing a magnetic field and transferring power. In theory, the magnetic core comprises magnetic circuits of the transformer, which transform power of a primary electric circuit into magnetic energy, and then transform such magnetic energy into power of a secondary electric circuit. The magnetic core serves as a medium for transferring energy. In structure, the magnetic core is the main frame of the transformer on which is put insulating coils. The current transformer has a structure of single magnetic circuit. Surrounding wires just like wires coated with lacquer onto the magnetic core forms the windings. However, this process has a large technology limit, and the input and output currents are extremely restricted. In addition, it requires too much for manufacturing materials of the windings, machine process and manufacturing environment, which increases the cost.

### BRIEF SUMMARY OF THE INVENTION

One object of the present invention is to provide a method for forming windings of a transformer, so as to reduce the requirements of manufacturing materials of the windings, machine process and manufacturing environment and save the manufacturing cost.

To achieve the above-mentioned object, an embodiment of the invention provides a method for forming windings of transformer windings, comprising:

enwinding windings on a plurality of magnetic circuits of a transformer.

Advantageously, the enwinding step further comprising:

enwinding wire or wires with continuously passing through a plurality of magnetic cores of the transformer in a vertical direction to the magnetic circuit, for forming windings which surround the a plurality of magnetic circuits.

Advantageously, the wire could be the single wire or paratactic several wires in the vertical direction of the magnetic circuit.

Advantageously, the wire is a single wire or a plurality of paratactic wires in the vertical direction to the magnetic circuit.

Advantageously, the wire is a wire coated with lacquer or a wire made of flat conductive plate.

Advantageously, the enwinding step further comprising:

enwinding equivalent windings made of printed circuit boards on the plurality of magnetic circuits of the transformer.

Advantageously, enwinding equivalent windings made of printed circuit boards in each magnetic circuit of the a plurality of magnetic circuits of the transformer respectively; or

enwinding equivalent windings made of printed circuit boards with continuously passing through a plurality of the magnetic circuits, whereby the a plurality of magnetic circuits share the equivalent windings.

Advantageously, the enwinding step further comprising:

folding a thin conductive material into a bending snake-like conductor;

folding the snake-like conductor into a closed-winding;

inserting a plurality of the magnetic cores of the transformer into a plurality of holes formed by the closed-winding correspondingly for forming windings which surround a plurality of the magnetic circuits.

Advantageously, a folding angle and width of the thin conductive material satisfy the following formula:

α=45°-0.5*αrc tan(S/2A);

λ=A*sin(90°-2α).

herein, the α expresses the folding angle, the λ expresses the width of the thin conductive material, the S expresses a width of window between two adjacent sides of the magnetic cores, and the A expresses a width of a cross section of the magnetic core of the transformer.

Advantageously, the engineering application value of the folding angle is α±15°.

Advantageously, the enwinding step further comprising:

folding a snake-like flat-plate material through mirror image for forming windings, an angle between two adjacent sides of the snake-like flat-plate material ranges from 120 to 150 degree;

inserting a plurality of the magnetic cores of the transformer into a plurality of holes formed by the windings correspondingly, for forming windings which surround a plurality of the magnetic circuits.

Advantageously, the method further comprising:

increasing layers of the windings enwinding on a plurality of the magnetic circuits of the transformer along a direction of the magnetic circuit, for forming a multi-layer windings.

Advantageously, the winding is a whole turn or half of a turn.

In the embodiment of the present invention, enwinding windings on a plurality of magnetic circuits of the transformer for forming a multi-magnetic circuits windings, so that the requirements for manufacturing materials of the windings, machine process and manufacturing environment are reduced. The manufacturing cost is consequently put down. Moreover, the hot spots of the transformer are dispersed through such a plurality of magnetic circuits, resulting in improving the heat radiation environment of the transformer, increasing the output power of the transformer which can be enlarged by infinitely extending.

### BRIEF DESCRIPTION OF THE DRAWINGS

FIG. 1 is a planform view of winding in a first embodiment of the present invention, which is formed by a single wire on a single layer;

FIG. 2 is a planform view of windings in the first embodiment of the present invention, which is formed by a plurality of wires on a single layer;

FIG. 3 is a planform view of windings in the first embodiment of the present invention, which is formed by a plurality of wires on a plurality of layers;

FIG. 4 is a planform view of half turn windings in the first embodiment of the present invention, which is formed by a single wire on a single layer;

FIG. 5 is a planform view of half turn windings in the first embodiment of the present invention, which is formed by a plurality of wires on a single layer;

FIG. 6 is a diagram of equivalent windings in each magnetic circuit of a transformer in a second embodiment of the present invention, which is made of printed circuit boards;

FIG. 7 is a diagram of two magnetic circuits share the equivalent windings made of printed circuit boards in the second embodiment of the present invention;

FIG. 8 is a diagram of half turn equivalent windings in the second embodiment of the present invention, which made of printed circuit boards;

FIG. 9 is a diagram of the folding figure of a thin conductive material in a third embodiment of the present invention;

FIG. 10 is a block diagram of a closed-winding in the third embodiment of the present invention;

FIG. 11 is another block diagram of the closed-winding in the third embodiment of the present invention;

FIG. 12 is a block diagram of the windings in FIG. 10 surrounded by the magnetic cores;

FIG. 13 is a block diagram of the windings in FIG. 11 surrounded by the magnetic cores;

FIG. 14 is a principle diagram of an angle and width required for folding the thin conductive material in the third embodiment of the present invention;

FIG. 15 is a block diagram of the windings with the principle in FIG. 14 in the third embodiment of the present invention;

FIG. 16 is a block diagram of a windings formed by snake-like flat-plate material through mirror image in a fourth embodiment of the present invention;

FIG. 17 is a diagram of some of the methods for making the snake-like flat-plate material in the fourth embodiment of the present invention;

FIG. 18 is a principle diagram of the efficiency of the snake-like flat-plate material in the fourth embodiment of the present invention.

### DETAILED DESCRIPTION OF THE INVENTION

The present invention now could be described more fully hereinafter with reference to the accompanying drawings, in which some, but not all embodiments of the inventions are shown. Indeed, the present invention may be embodied in many different forms and should not be construed as limited to the embodiments set forth herein.

In a first embodiment of the present invention enwinding wire or wires with continuously passing through a plurality of magnetic cores of the transformer in a vertical direction to the magnetic circuit, for forming windings which surround the magnetic circuits. For example, take a single wire with continuously passing through a plurality of magnetic cores of the transformer in the vertical direction to the magnetic circuit, for forming windings which surround the magnetic circuits.

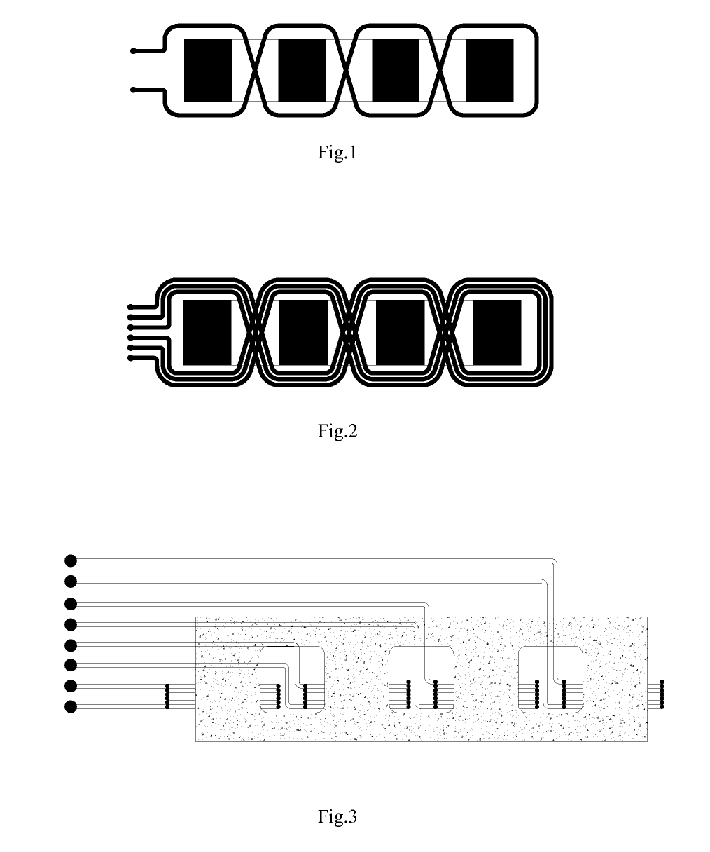

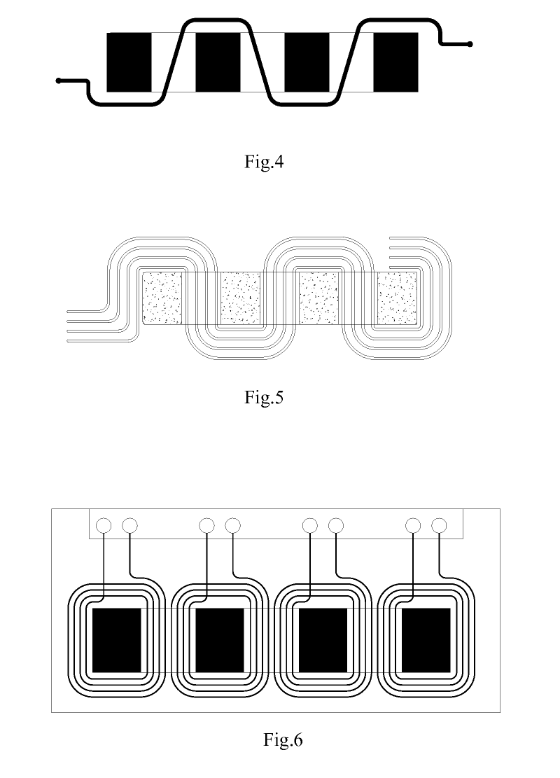

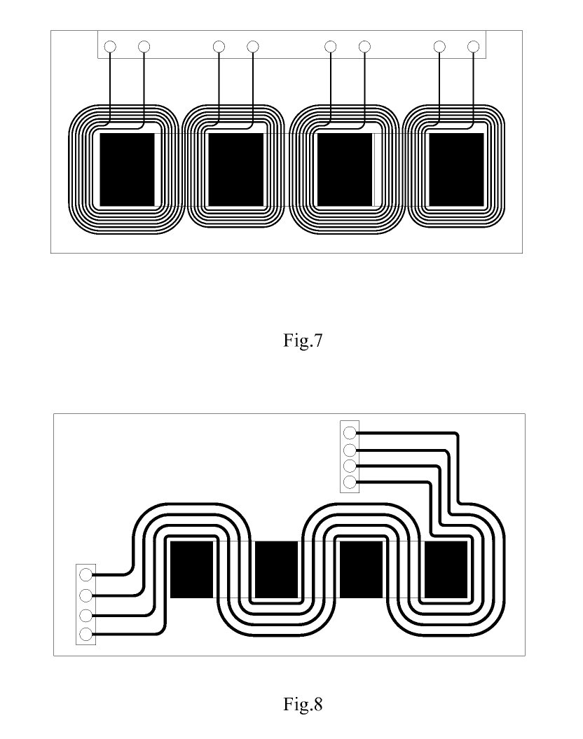

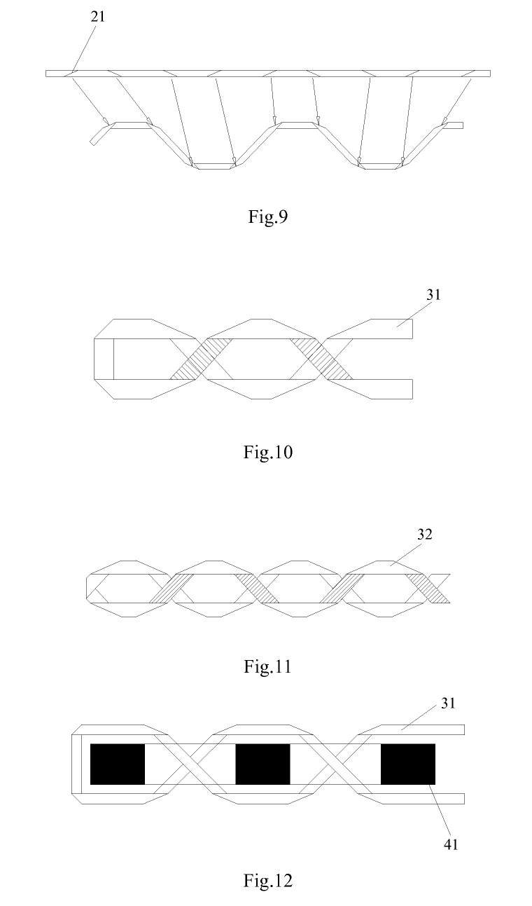

As shown in FIG. 1, taking the transformer having four magnetic cores as an example, the method for forming windings of the transformer includes steps as the following:

1. a start end of the wire passing through the top of the first magnetic core, crosses the space between the first magnetic core and the second magnetic core to the bottom of the second magnetic core; 2. crossing the space between the second magnetic core and the third magnetic core from the bottom of the second magnetic core to the top of the third magnetic core; 3. crossing the space between the third magnetic core and the fourth magnetic core from the top of the third magnetic core to the bottom of the fourth magnetic core; 4. crossing from the bottom of the fourth magnetic core to the top of the fourth magnetic core; 5. crossing from the top of the fourth magnetic core to the bottom of the third magnetic core; 6. crossing from the bottom of the third magnetic core to the top of the second magnetic core and finally arriving at the bottom of the first magnetic core for forming the terminal. It is obvious that, the way the wire enwinding from the fourth magnetic core to the first magnetic core is contrary to enwinding from the first magnetic core to the fourth magnetic core. Certainly, it is available for crossing from the bottom of the first magnetic core to the top of the fourth magnetic core and enwinding to the bottom of the fourth magnetic core, then crossing from the bottom of the fourth magnetic core and going back to the top of the first magnetic core. The start end and the terminal end of the wire form the taps for peripheral equipments to connect the windings. By this way, a single winding laid on a single layer is accomplished. If the transformer has more magnetic cores, the process for forming windings is similar to that of mentioned above. By increasing the number of the layer of the windings having single wire on a single layer along the direction with the magnetic circuit, the single-wire on multi-layers windings are thus formed. Connecting the multi-layers windings parallel or in series could change an inductance value of the transformer, resulting in changing the transformation ratio, and extending the application field of the transformer.

In a first embodiment of the present invention, if a transformer is sensitive to engross a window space, place a number of parallel wires in a vertical direction to the magnetic circuit for better use of the window space. When considering the vortex loss of the wire, Place a number of parallel wires (parallel) in a vertical direction to the magnetic circuit is an effective choice, here, the actual lengths of the plurality of wires are the same. Thus, the “transposition” operation which the traditional transformer is doing on a plurality of wires paralleled can be omitted.

As shown in FIG. 2, in a first embodiment of the present invention, enwinding wire with continuously passing through a plurality of magnetic cores of the transformer in a vertical direction to the magnetic circuit, for forming windings which is plural-wires on a single layer, for forming windings which is a single wire on a single layer is the same with the above. Correspondingly, as shown in FIG. 3, if increasing the layers of the windings enwinding on a plurality of magnetic circuits of the transformer along the direction with the magnetic circuit, could form windings which are multi-wires on multi-layers.

As shown in FIGS. 4 and 5, in specific applications of the present invention, the winding is half a turn, but which has large leaking magnetism and limited applications. In an embodiment of the present invention, the wire is coated with lacquer or made of a material of flat conductive plate. The wire coated with lacquer further could be a circle, and should be flat when making multi-wires windings.

In a first embodiment of the present invention, enwinding wires with continuously passing through a plurality of magnetic cores of the transformer in a vertical direction to the magnetic circuit, for forming windings which surround the magnetic circuits. Thus, the requirements for manufacturing materials of the windings, machine process and manufacturing environment are reduced. The manufacturing cost is consequently put down. Moreover, the hot spots of the transformer are dispersed through such a plurality of magnetic circuits, resulting in improving the heat radiation environment of the transformer, increasing the output power of the transformer which can be enlarged by infinitely extending.

In a second embodiment of the present invention, enwinding equivalent windings made of printed circuit boards (PCB) on a plurality of magnetic circuits of a transformer for forming windings. In this embodiment, the magnetic circuits can use the equivalent windings independently, or share the equivalent windings together.

As shown in FIG. 6, taking the transformer having four magnetic cores as an example, enwinding equivalent windings made of PCB in each magnetic circuit of the transformer, according to the need of transformation, in series or parallel the equivalent windings selectively, thereby improving the heat radiation environment of the transformer, increasing the output power of the transformer which can be enlarged by infinitely extending. As shown in FIG. 7, two of the four magnetic circuits share the equivalent windings. And, as shown in FIG. 8, four magnetic circuits share the half turn equivalent windings. In this embodiment, the PCB boards are one or more layers.

Using the windings made in this embodiment, the transformer can achieve high inductance value. In such circumstances, the transformer can be used in relatively low-frequency (industry universal frequency With the industrial base), thus, the cost of the transformer and the loss of the transformer working with other devices will be reduced.

Simultaneously, when using PCB board to make the windings, can making assistant circuit compatible with the windings, thus, the cost of the transformer will be reduced.

In a third embodiment of the present invention, folding thin conductive material into a bending and snake-like conductor; folding the snake-like conductor into a closed-winding; inserting a plurality of magnetic cores of the transformer into a plurality of holes formed by the closed-winding to form windings which surround a plurality of magnetic circuits, every hole surrounds one magnetic core. In this embodiment, the thin conductive material is aluminum material or copper material.

FIG. 9 shows a diagram of a folding figure of the thin conductive material in the third embodiment of the present invention, folding the thin conductive material into snake-like conductor according to the line 21 shown in FIG. 9. As shown in FIG. 10, fold the snake-like conductor again into a closed-winding31. As shown in FIG. 11, folding the snake-like conductor shown in FIG. 9 twice into winding32, in this situation, the length of the winding32 could be extended indefinitely in the direction of left and right.

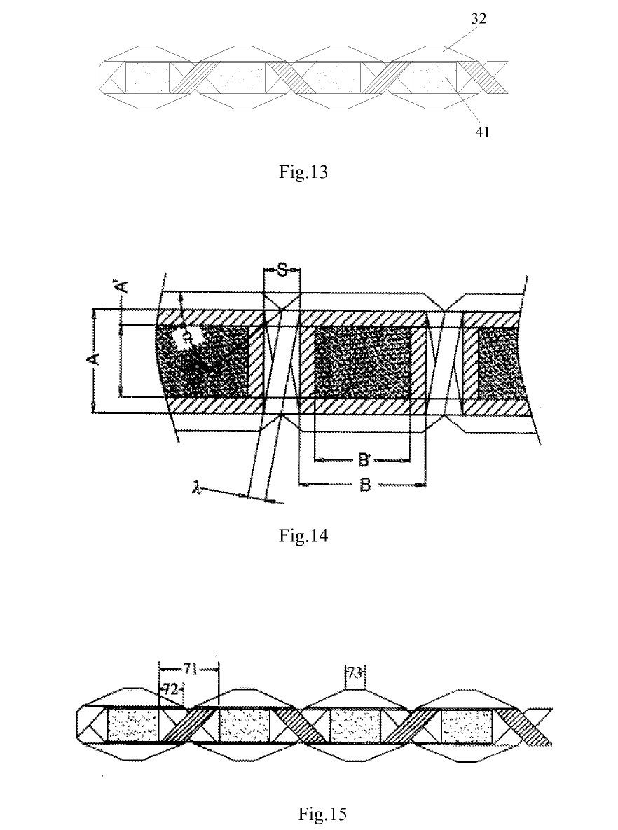

In this embodiment, inserting a plurality of magnetic cores of the transformer into the windings after the windings formed. FIG. 12 and FIG. 13 show a block diagram of the windings in FIG. 10 surrounded by the magnetic cores 41 respectively. In the figures, the windings 31 or 32 are surrounded the magnetic circuits while inserting the magnetic cores 41.

As shown in FIG. 14, if the magnetic core is standard, the width of window and the size of the magnetic core are identified, a folding angle and width of the thin conductive material satisfy the following formula:

α=45°-0.5*αrc tan(S/2A)

λ=A*sin(90°-2α).

herein, the α expresses the folding angle, the λ expresses the width of the thin conductive material, the S expresses a width of window between two adjacent of the magnetic cores, and the A expresses a width of a cross section of the magnetic core of the transformer.

The value of the α mentioned above is a theoretical value. In practical application, the engineering application value of the folding angle is α±15°.

Based on the principle above, as shown in FIG. 15, if the transversal length 71 formed when the winding tilting through the windows is less than or equal to the half of the width 72 of the window, the action for folding the thin conductor can not be overlap. However, the transversal length 71 is smaller; the utilization ratio of the space is lower. If the second fold distance 73 of the tilt windings is less than the half of the width of the cross section of the magnetic core, the second fold can also satisfy the request of that the action for folding the thin conductor cannot be overlap. It is obvious that, the width of thin-conductor is narrower; the folded windings have better performance at all points. Consequently, in this embodiment, it is required to increase the width of the thin conductor for increasing the effective conductive area, at the same time, increasing the width can be effectively for compressing the thickness of the windings.

In a fourth embodiment of the present invention, folding snake-like flat-plate material through mirror image for forming windings, an angle between two adjacent sides of the snake-like flat-plate material ranges from 120 to 150 degrees; further, Inserting a plurality of magnetic cores of the transformer into a plurality of holes formed by the closed-winding for forming windings which is surround a plurality of magnetic circuits, every hole surrounds one magnetic core.

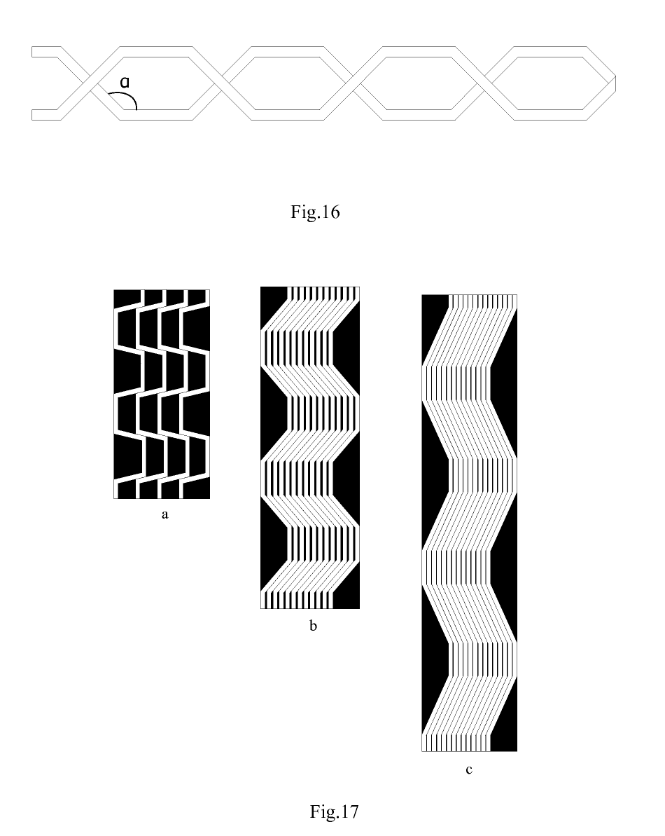

In this embodiment, as shown in FIG. 16, a snake-like flat-plate material is folded through mirror image for forming winding. When machining the snake-like flat-plate material, it is required to incise a number of snake-like flat-plate materials from a whole block flat-plate, so the manufacturing cost of the windings is affected by the utilization ratio of the plate. FIG. 17 shows three ways for incising a plate, each way has different utilization ratio of the plate.

In this embodiment of the present invention, the formula for calculating the utilization ratio of the plate is as following:

$$\{ 1 - \frac{( 1 - 2 \sqrt{2} ) {c}^{2} + ( \sqrt{2} - 1 ) bc + 2 c}{( 5 - \sqrt{2} ) {c}^{2} + 2 \sqrt{2} ac + ( \sqrt{2} - 1 ) bc + 4 \sqrt{2} ec + 2 c} \} \times 100 \%$$

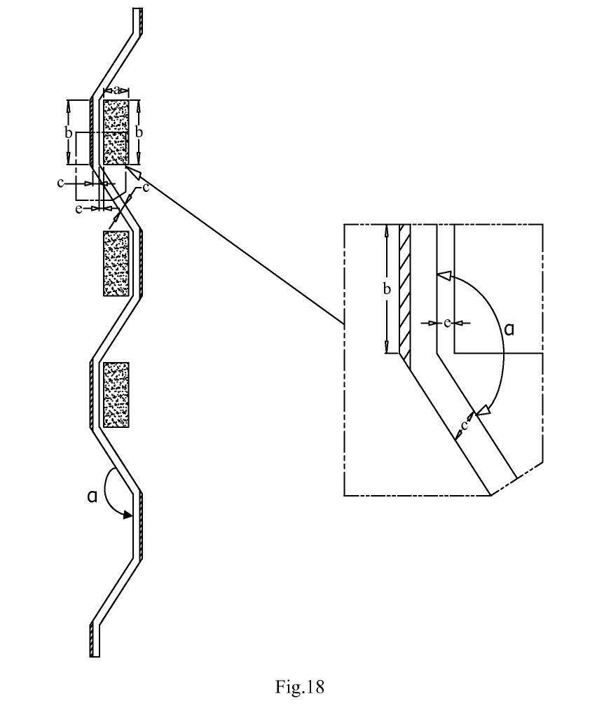

hereinto, a expresses a width of a cross section of the magnetic core, b expresses a length of the cross section of the magnetic core, c expresses a width of a snake-like flat-plate material which for forming the winding, and e expresses a safety (art) distance between the winding and the magnetic core during the engineering application. As shown in FIG. 18, according to the formula mentioned above, if a=b and the angle between two adjacent sides of the snake-like flat-plate material is 135 degree, only zero point four times width of the windings will be wasted, at that time, the utilization ratio of the plate is the largest. The discussion above is the theoretical value of the utilization of the plate, the engineering application value of the folding angle could be α±15°.

In the fourth embodiment of the present invention, the requirements for manufacturing materials of the windings, machine process and manufacturing environment are reduced. The manufacturing cost is consequently put down. Moreover, the heat radiation problem has been overcame when the transformer working in big current environment, thereby increasing the utilization of the whole plate, and saving material for forming windings.

It is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for forming windings of a transformer, comprising:
enwinding windings on a plurality of magnetic circuits of a transformer.

2. The method as claimed in claim 1, wherein the enwinding step further comprising:
enwinding wire or wires with continuously passing through a plurality of magnetic cores of the transformer in a vertical direction to the magnetic circuit, for forming the windings which surround a plurality of the magnetic circuits.

3. The method as claimed in claim 2, wherein the wire is a single wire or a plurality of paratactic wires in the vertical direction to the magnetic circuit.

4. The method as claimed in claim 1, wherein the wire is a wire coated with lacquer or a wire made of flat conductive plate.

5. The method as claimed in claim 1, wherein the enwinding step further comprising:
enwinding equivalent windings made of printed circuit boards on a plurality of the magnetic circuits of the transformer.

6. The method as claimed in claim 5, wherein the enwinding step further comprising:
enwinding the equivalent windings made of printed circuit boards in each magnetic circuit of a plurality of the magnetic circuits of the transformer respectively; or
enwinding the equivalent windings made of printed circuit boards with continuously passing through a plurality of the magnetic circuits, whereby the a plurality of magnetic circuits share the equivalent windings.

7. The method as claimed in claim 1, wherein the enwinding step further comprising:
folding a thin conductive material into a bending snake-like conductor;
folding the snake-like conductor into a closed-winding;
inserting a plurality of the magnetic cores of the transformer into a plurality of holes formed by the closed-winding correspondingly for forming windings which surround a plurality of the magnetic circuits.

8. The method as claimed in claim 7, wherein a folding angle and width of the thin conductive material satisfy the following formula:
α=45°-0.5*αrc tan(S/2A);
λ=A*sin(90°-2α).
herein, the α expresses the folding angle, the λ expresses the width of the thin conductive material, the S expresses a width of window between two adjacent sides of the magnetic cores, and the A expresses a width of a cross section of the magnetic core of the transformer.

9. The method as claimed in claim 8, wherein the engineering application value of the folding angle is α±15°.

10. The method as claimed in claim 1, wherein the enwinding step further comprising:
folding a snake-like flat-plate material through mirror image for forming windings, an angle between two adjacent sides of the snake-like flat-plate material ranges from 120 to 150 degree;
inserting a plurality of the magnetic cores of the transformer into a plurality of holes formed by the windings correspondingly, for forming windings which surround a plurality of the magnetic circuits.

11. The method as claimed in claim 1, wherein the method further comprising:
increasing layers of the windings enwinding on a plurality of the magnetic circuits of the transformer along a direction of the magnetic circuit, for forming a multi-layer windings.

12. The method as claimed in claim 1, wherein the windings are a whole turn or half of a turn.
